(19) United States
(12) Patent Application Publication
(10) Pub. No.: US 2007/0081089 A1
(43) Pub. Date: Apr. 12, 2007

(54) Electronic image pickup apparatus

(75) Inventors: Tatsuji Higuchi, Akiruno-shi (JP); Masaaki Daigaku, Tama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS OPTICAL CO., LTD., Shibuya-ku (JP)

(21) Appl. No.: 11/636,958

(22) Filed: Dec. 12, 2006

Related U.S. Application Data
(63) Continuation of application No. 10/686,633, filed on Oct. 17, 2003.
Application No. 10/686,633 is a continuation of application No. 09/219,857, filed on Dec. 23, 1998, now abandoned.

(30) Foreign Application Priority Data
Dec. 25, 1997 (JP) 9-366194

(51) Int. Cl. H04N 5/222

(52) U.S. Cl. 348/333.06

(57) ABSTRACT

In an electronic image pickup apparatus where an object light after passing through a taking lens unit having a plurality of lenses is photoelectrically converted at an image pickup device to be recorded, the taking lens unit is constructed as having a reflecting mirror located between the lenses so that a light incident thereupon is bent, and is disposed such that it be positioned in front of an image display section provided on a back surface of the body with a length direction thereof being perpendicular to a bottom surface of the body. The electronic image pickup apparatus is thereby achieved as having a well-balanced configuration where the body is neither increased in thickness nor too long in a lateral dimension.

This application is a continuation of U.S. patent application Ser. No. 10/686,633 filed on Oct. 17, 2003, which is a continuation of U.S. patent application Ser. No. 09/219,857 filed on Dec. 23, 1998, the entire contents of which are hereby incorporated by reference.

### BACKGROUND OF THE INVENTION

The present invention relates to electronic image pickup apparatus, and more particularly relates to an electronic image pickup apparatus which is improved in arrangement of taking lens unit and disposition of internal units.

Since a larger number of component parts, when compared to a camera using silver film, are generally provided at the interior of electronic image pickup apparatus, particularly of an electronic camera (commonly called as digital still camera), the camera body tends to be increased in size and reduced in portability. A number of proposals have thus been made aiming at reduction in size thereof. Especially, an increase in thickness in direction of optical axis of the camera body adversely affects not only its portability but also its stability when held for taking image. Among the factors to be considered as the cause of an increased thickness are an optical path length of optical system and disposition of various boards for mounting electric circuits, a display section such as LCD, etc.

First, in respect of an optical path length of optical system, it is well known to achieve a compact camera body without changing a total length of the optical path length by bending the optical system at a midpoint in the course of its optical path. For example, a disclosure has been made in Japanese patent application laid open No. 9-281578 with respect to a camera apparatus capable of compacting the apparatus as a whole in which: a conversion lens for wide angle is disposed as capable of a rotary movement on the incidence side of a telephoto master lens for forming image of an object on the image pickup surface of a solid-state image pickup device; the converter lens is turned and moved between a position on an optical path from the object to the master lens and a position outside the optical path; and a reflecting mirror is disposed at the center of turning of the converter lens, thereby setting a length of the apparatus by a short optical path length from the image pickup surface to the reflecting mirror.

Similarly, Japanese patent application laid open No. 9-211287 discloses an image pickup apparatus in which a prism body having its hypotenuse surface as an internal reflecting surface for reflecting and deflecting luminous flux is attached on the object side of the taking system to pick up an image through the prism body, thereby reducing the length in a horizontal direction of the taking system.

Further, in respect of disposition of various boards for mounting electric circuits and image display section such as LCD, it has conventionally been common to prevent an increase in thickness by employing a layout where the taking optical system is disposed at an end portion of the apparatus body so as not to cause an overlapping of the taking optical system with the various electric circuit boards, image display section, etc., in direction of thickness at the interior of the apparatus body.

As in the above, bending of the taking optical system for reducing a thickness of the apparatus is shown in Japanese patent application laid open No. 9-281578 or Japanese patent application laid open No. 9-211287. However, a thickness of the apparatus is determined not solely by the physical dimensions of the taking optical system, and, as described above, its relative disposition with respect to the print circuit boards and/or image display section is also an important factor. Further, the mere fact of a small thickness of the apparatus does not meet the portability and/or operability of the apparatus and, in some cases, can even adversely affect readiness of manipulation. Actually, with the construction as diagrammatically illustrated in the above Japanese patent application laid open No. 9-281578, shape and layout thereof are seriously restricted and a problem for example in operability may occur due to the fact that position of the taking optical system is confined to a left or right end portion of the apparatus body or the fact that a camera is elongated from side to side in order to secure an area for the boards, etc. Even when the taking optical system is contained within the apparatus body, a similar problem occurs if the taking optical system is disposed at an end portion of the interior of the apparatus body so as not to cause an overlap with the various electric circuit boards, image display section, etc.

### SUMMARY OF THE INVENTION

To eliminate the above problems in conventional electronic image pickup apparatus, it is a main object of the present invention to provide an electronic image pickup apparatus having a well-balanced configuration as a whole in which a reduction in thickness of the apparatus body is achieved and at the same time a well-balanced configuration as a whole and favorable operability thereof are maintained with taking account of disposition of the components parts at the interior, and, in particular, the apparatus body is neither increased in thickness nor too long in a lateral dimension.

In accordance with the present invention, there is provided an electronic image pickup apparatus including: a taking lens unit having a plurality of lenses; an image pickup device for effecting photoelectric conversion of an object light after passing through the taking lens unit; and recording means for recording image pickup signal obtained by effecting photoelectric conversion at the image pickup device. The taking lens unit includes between the lenses optical axis alteration means for altering the direction of image pickup optical axis and the taking lens unit is disposed in front on the object side of an image display section for displaying an image located on a back surface of the apparatus body.

The taking lens unit can be bent in the course thereof, since, as described above, it includes between the lenses the optical axis alteration means for altering the direction of image pickup optical axis. Further, the image display section is disposed on the back side of the taking lens unit. The electronic image pickup apparatus can thus be realized as having a well-balanced configuration where the apparatus body is neither increased in thickness nor too long in a lateral dimension. The above main object is thereby accomplished.

It is another object of the present invention to provide an electronic image pickup apparatus in which the relative disposition of a device for adjusting quantity of light is suitably adapted to achieve a reduction in thickness thereof.

In accordance with the present invention, a device for adjusting quantity of light which mechanically adjusts the quantity of light passing through the taking lens unit is provided between the optical axis alteration means and the image pickup device located within the taking lens unit to accomplish this object. In particular, the device for adjusting quantity of light is disposed at a position after the optical axis alteration means, i.e., after the bent of the taking lens unit, thereby contributing to a reduction in thickness of the electronic image pickup apparatus.

It is still another object of the present invention to provide an electronic image pickup apparatus in which the relative disposition of a lens displacing mechanism is suitably adapted to achieve a high level of function of the taking lens unit while maintaining a reduced thickness thereof.

In accordance with the present invention, a lens displacing mechanism for displacing lenses in the direction of the optical axis is provided within the taking lens unit between the optical axis alteration means and the image pickup device to accomplish this object. In particular, by thus disposing the lens displacing mechanism after the optical axis alteration means, it is possible to achieve a high level of function of the taking lens unit while maintaining a reduced thickness of the apparatus body.

It is yet another object of the present invention to provide an electronic image pickup apparatus in which disposition of an image pickup device is suitably adapted to reduce occurrence of electrical noise and at the same time to be able to readily spread heat.

In accordance with the present invention, the taking lens unit is disposed in the apparatus body such that the image pickup optical axis altered by the optical axis alteration means is plumb in the posture of the apparatus body at the time of a customary taking of image and the image pickup device is disposed in the vicinity of the bottom surface of the apparatus body to accomplish this object. In particular, by thus disposing the image pickup device in the vicinity of the bottom surface of the apparatus body, since clearance to other electric circuit boards as well as to an image displaying section can be increased, it is possible to reduce occurrence of electrical noise and at the same time to readily perform spreading of heat, etc.

It is a further object of the present invention to provide an electronic image pickup apparatus in which degradation of image pickup signal is reduced and thickness of the apparatus body is reduced by suitably adapting disposition of an electric circuit board.

In accordance with the present invention, an electric circuit board mainly mounting an image pickup circuit for processing image pickup signal of an image pickup device is disposed between the image pickup device and the bottom surface of the apparatus body to accomplish this object. In particular, by thus disposing the above described electric circuit board close to the image pickup device in parallel to the bottom surface of the body, degradation of image pickup signal is reduced and at the same time thickness of the apparatus body can be reduced. Further, since the above described electric circuit board is disposed on the bottom surface side of the apparatus body, it is less likely to be affected by noise from other boards.

It is a further object of the present invention to provide an electronic image pickup apparatus in which disposition of the taking lens unit is suitably adapted to lower the height of the apparatus body at the same time of reducing thickness thereof.

In accordance with the present invention, the above object is accomplished by disposing the taking lens unit in the apparatus body such that the image pickup optical axis altered by the optical axis alteration means is horizontal in the posture of the apparatus body at the time of a customary taking of image. In particular, since, in such construction, the taking lens unit is disposed in a manner laid down in a lateral direction, the height of the apparatus body can be lowered at the same time of reducing thickness thereof so as to realize a well-balanced configuration of the apparatus body.

It is a further object of the present invention to provide an electronic image pickup apparatus in which disposition of an electric circuit board is suitably adapted to secure a sufficient area for the electric circuit board and at the same time to achieve a reduction in thickness of the apparatus body.

In accordance with the present invention, an electric circuit board mainly mounting an image pickup circuit for processing image pickup signal of the image pickup device is disposed between the taking lens unit and an image displaying section to accomplish this object. In particular, by such construction, since a harness can be connected in a short distance from the image pickup device to the electric circuit board, degradation of image pickup signal can be reduced. Further a sufficient area can be secured on the electric circuit board and it is thereby possible to achieve a reduction in thickness of the apparatus body.

It is a further object of the present invention to provide an electronic image pickup apparatus in which an incidence of unwanted external light by itself upon the taking lens unit can be reduced.

In accordance with the present invention, the above object is accomplished by providing a means for cutting unwanted external light in the vicinity of part of the taking lens unit upon which an object light is incident. In particular, by thus providing the means for cutting unwanted external light in front of the taking lens unit, an incidence of unwanted external light by itself upon the taking lens unit can be reduced. Accordingly, even when an optical axis alteration means is provided within the taking lens unit, an occurrence of flare ghost can be prevented.

It is a further object of the present invention to provide an electronic image pickup apparatus in which a means for cutting unwanted external light is constructed as having a simple construction.

In accordance with the present invention, the above object is accomplished by constituting a part of the means for cutting unwanted external light by an end edge portion of a taking lens protection cover disposed in front of the taking lens unit and provided as displaceable between a position for concealing the taking lens unit and a position for opening the same. In particular, since, in this manner, a part of the means for cutting unwanted external light is constituted by an end edge portion of the taking lens protection cover, it is adequate to move it so as to make the end edge portion of the taking lens protection cover a part of the means for cutting unwanted external light. A smaller amount of sliding of the taking lens protection cover suffices.

It is a further object of the present invention to provide an electronic image pickup apparatus in which disposition of a means for cutting off unwanted external light is suitably adapted to achieve a reduction in thickness of the apparatus body.

In accordance with the present invention, the means for cutting unwanted external light is integrally formed as a protrusion on an external enclosure portion of the apparatus body to accomplish the above object. In particular, by thus forming the means for cutting unwanted external light as a protrusion on the external enclosure portion of the apparatus body, a front lens of the taking lens unit can be disposed at a position closer to the front surface of the apparatus body, thereby contributing to a reduction in thickness of the apparatus body.

It is a further object of the present invention to provide an electronic image pickup apparatus in which disposition of a driving source for driving a lens displacing mechanism is suitably adapted to achieve a reduction in thickness of the apparatus body.

In accordance with the present invention, the driving source for driving the lens displacing mechanism is disposed on a lateral side of the taking lens unit to accomplish the above object. In particular, by thus disposing the driving source for driving the lens displacing mechanism on a lateral side of the taking lens unit, a reduction in thickness of the apparatus body can be achieved without an increase in a dimension of the taking lens unit as a whole in the direction of thickness of the apparatus body.

It is a further object of the present invention to provide an electronic image pickup apparatus in which AF operation is effected by drive of the image pickup device so as to simplify the structure of the taking lens unit.

In accordance with the present invention, the above object is accomplished by providing an image pickup device displacing mechanism for displacing the image pickup device along the axis of light incident upon the image pickup surface. In particular, by such construction, AF operation can be effected by directly driving the image pickup device and the structure of the taking lens unit can be simplified.

It is a further object of the present invention to provide an electronic image pickup apparatus in which IR cut filter is omitted to achieve a reduction in size of the apparatus body.

In accordance with the present invention, the above object is accomplished by constituting the optical axis alteration means by a reflecting mirror having IR cut film vapor-deposited thereon. In particular, since an IR cut filter becomes unnecessary in such construction, it can contribute to a reduction in size of the apparatus body.

It is a further object of the present invention to provide an electronic image pickup apparatus of single lens reflex type having a reduced thickness.

In accordance with the present invention, the above object is achieved by constituting the optical axis alteration means by a beam splitter for splitting an incident light into a plurality of components so that rays of light reflected at a semi-transparent surface of the beam splitter enter the image pickup device and rays of light after passing through the semi-transparent surface of the beam splitter enter an optical finder for visually recognizing an object. In particular, by constructing in this manner, the electronic image pickup apparatus can be realized as a single lens reflex type having a reduced thickness.

It is a further object of the present invention to provide an electronic image pickup apparatus of single lens reflex type having a reduced thickness without using a beam splitter.

In accordance with the present invention, the above object is accomplished by moving an optical axis alteration means between a first position where it alters direction of an object light so as to cause an incidence thereof upon the image pickup device and a second position retracted from the path of rays of the incident light where the object light enters an optical finder for visually recognizing the object. In particular, by constructing in this manner, a beam splitter is not used and it is possible to realize a single lens reflex type electronic image pickup apparatus having a reduced thickness where a reduction in quantity of light for taking an image is small and image quality is favorable.

### BRIEF DESCRIPTION OF THE DRAWING

FIG. 1 is a perspective view of an external appearance as seen from front side of a first embodiment of the electronic image pickup apparatus according to the present invention.

FIGS. 2A, 2B are a front view and a sectional view, respectively, illustrating in detail the vicinity of a taking lens aperture in the first embodiment shown in FIG. 1.

FIGS. 3A, 3B, 3C each show an internal layout of the first embodiment shown in FIG. 1.

FIG. 4 is a sectional front view of certain portions of the taking lens unit of the first embodiment shown in FIG. 1.

FIG. 5 is a sectional side view of certain portions of the taking lens unit of the first embodiment shown in FIG. 1.

FIGS. 6A, 6B, 6C each show an internal layout of a second embodiment of the present invention.

### DESCRIPTION OF THE PREFERRED EMBODIMENTS

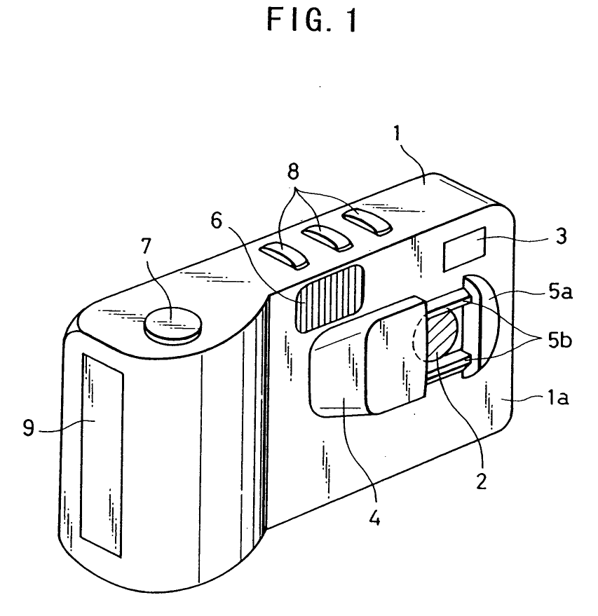

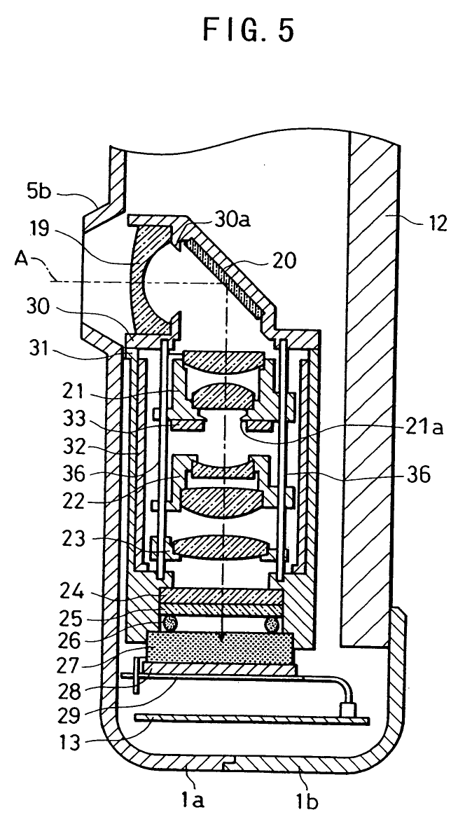

An embodiment of the present invention will now be described. FIG. 1 is a perspective view of external appearance as viewed from a front side of a first embodiment of the electronic image pickup apparatus according to the present invention. This embodiment is achieved by applying the present invention to an electronic camera, and the directions of left and right in the following description are defined as viewed from the side of an object to be photographed unless otherwise specified. Referring to FIG. 1, what is denoted by numeral 1 is an electronic camera body. Disposed respectively on the front surface of a front cover (external enclosure) 1a for protecting the front side of the camera body 1 are: an aperture 2 for the taking lens somewhat toward the right from the center; a transparent window of an optical finder 3 for visually recognizing an object above the taking lens aperture 2 and further toward the right side of the camera body 1; and a strobe window 6 at a center upper portion. A plurality of optical component parts are provided within the optical finder 3 so that a photographer can visually recognize an object at the time of taking a picture through an ocular window (not shown) provided on a rear cover 1b (see FIG. 5) for protecting the back side of the camera body 1.

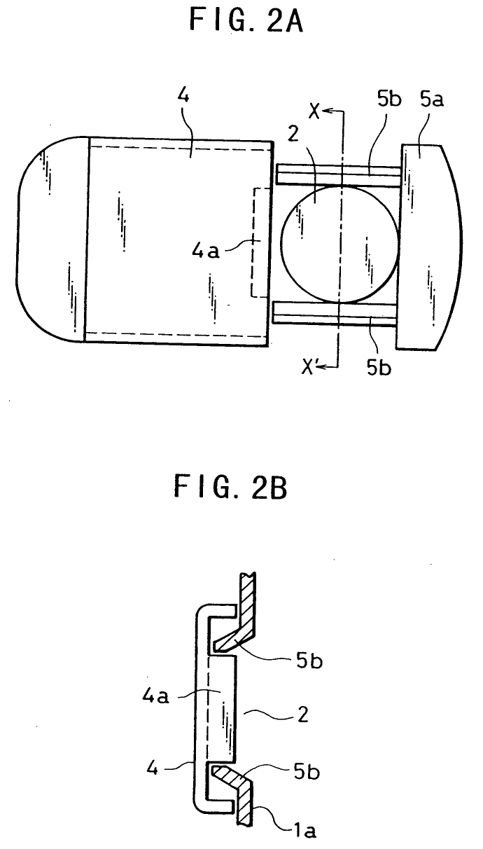

Provided at the interior of the strobe window 6, a transparent window, is a xenon tube for strobe emission which is caused to emit by control of a strobe circuit located at the interior of the body. A lens protection cover 4 at a center portion is provided as capable of sliding in the right and left direction in front of the front cover 1a in such a manner as to cover and protect the taking lens aperture 2 when not taking a picture and to make a picture taking possible by opening the taking lens aperture 2 when taking a picture. The taking lens protection cover 4 in FIG. 1 is shown in its opened state. Denoted by numerals 5a and 5b are a first protruding part and a second protruding part, respectively, integrally formed on the front cover 1a, in a configuration surrounding the taking lens aperture 2. These will be later described in detail by way of FIG. 2.

The camera body 1 as viewed from the front side thereof is shaped to bulge out in the direction of thickness on the left side as compared to the right side. The bulging portion becomes a grip for the photographer when a picture is to be taken by the camera so that the camera body 1 can be stably held. A lid 9 for attaching and detaching an external memory is provided at a left end portion of the camera body 1 which constitutes-a part of the grip, the lid 9 being disposed as turnable with respect to the camera body 1. The lid 9 in FIG. 1 is shown in its closed state. In the state where the lid 9 is closed, the external surface of the lid 9 is not caused to protrude from the external surface of the camera body 1 so as to form an identical surface. Further, switches for operating the camera are provided on the upper surface of the camera body 1. A release switch 7 is the switch for recording image to a memory when taking a picture, and mode switches 8 are for switching recording modes when taking a picture.

FIG. 2A is a front view for showing in detail the vicinity of a taking lens aperture 2 in the state where the taking lens protection cover 4 is opened, and FIG. 2B is a sectional view of certain portions where a section along line X-X′ near the center of the taking lens aperture 2 is seen from the right side. A first group lens 19 of a taking lens unit 11 to be described later is provided at the interior of the taking lens aperture 2. Formed integrally on the front cover 1a in a manner surrounding three sides of the taking lens aperture 2 are the first protrusion 5a projecting from the front surface of the front cover 1a on the right side thereof and a pair of second protrusions 5b one step lower than the first protrusion 5a on upper and lower sides. Here, when the taking lens protection cover 4 is opened, a wall portion 4a integrally provided on an inner end surface of the taking lens protection cover 4 is positioned on the left side of the taking lens aperture 2. Accordingly, these protrusions and wall surrounding the taking lens aperture 2 from upper and lower as well as left and right sides constitute a means for shutting off unwanted external light to prevent an entrance into a front lens of the taking lens unit 11 of a harmful light obliquely incident upon the camera body 1 which is not a genuine object light. This acts as a so-called hood. It is thereby: possible to readily prevent a flare ghost without specifically providing a hood.

The same effect can naturally be obtained by forming a hood such as in annular shape on the front cover 1a. In this case, however, it is disadvantageous in achieving a smaller size corresponding to the fact that a larger traveling distance of the taking lens protection cover 4 must be provided toward the direction of its opened state so that it can go beyond the hood. In the present embodiment, an effect of preventing a flare ghost can be obtained by the wall portion 4a formed at an end portion of the protection cover 4, even when the position of the taking lens protection cover 4 in its opened state can go not much beyond a position at the very limit of the taking lens aperture 2, i.e., a hood such as in annular shape cannot be distinctly formed. It is advantageous in achieving a smaller size.

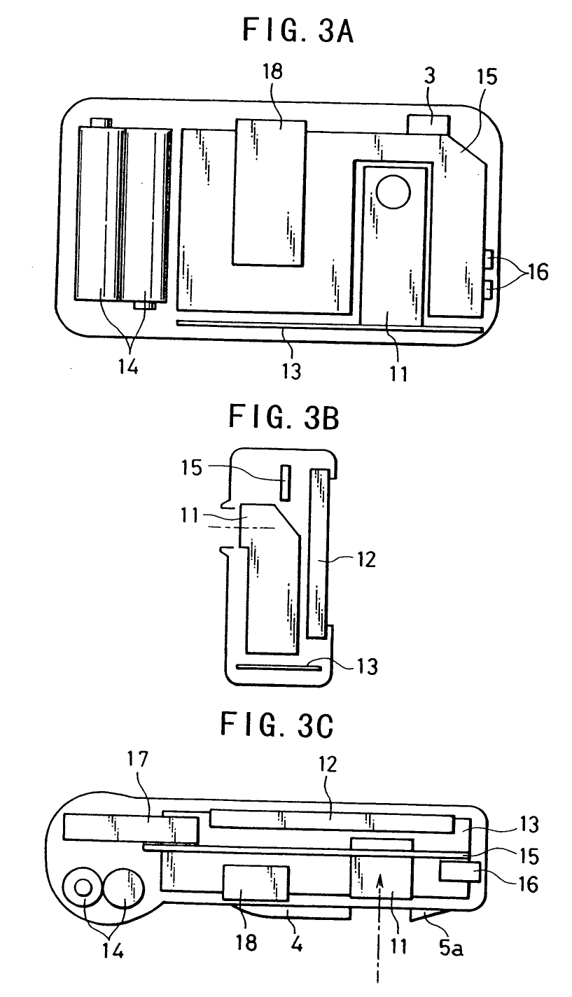

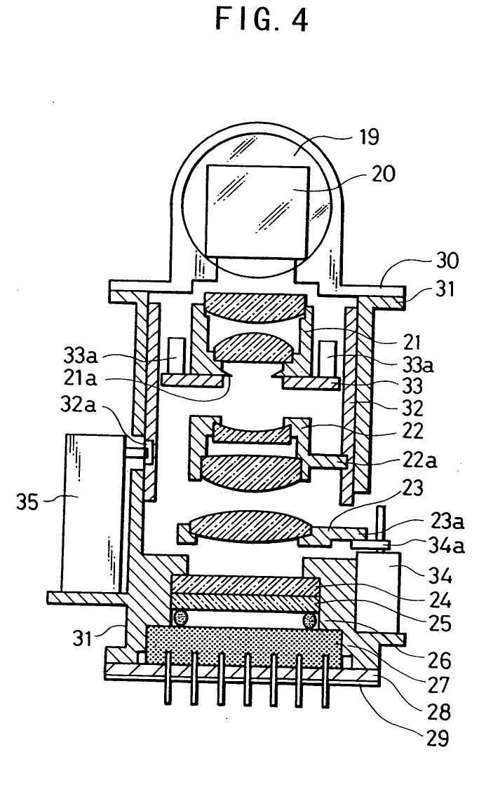

FIGS. 3A to 3C show an internal layout of the electronic camera of the first embodiment shown in FIG. 1. FIG. 3A shows the layout of certain component parts at the interior as viewed from the front side, FIG. 3B from the right and FIG. 3C from the top. In these figures, numeral 11 denotes a taking lens unit. The taking lens unit 11 has a vertically elongated shape and is disposed somewhat toward right from the center on the camera body such that its length direction is perpendicular to the bottom surface of the camera body. Provided at the interior of the taking lens unit 11 are a plurality of lenses and optical component parts for forming an object image as well as an image pickup device for effecting photoelectric conversion at the image forming plane. Its detailed construction will be described later by way of FIGS. 4 and 5.

An image pickup board 13 is the electric circuit board mainly mounting an image pickup circuit for performing control of drive of the image pickup device and processing of electrical signals photoelectrically converted by the image pickup device. It is disposed in parallel to the bottom surface of the camera body at a position under the taking lens unit 11. A main board 15 is disposed in parallel to the front surface of the camera body and substantially has a form of U in such a manner as to straddle the taking lens unit 11. Provided on the main board 15 are: a main CPU for performing system processing of the whole; a compressing/expanding circuit for image signal; a control circuit for controlling motor, etc., provided on the taking lens system to be described later; a room 17 for accommodating an attachable/detachable memory internally having a connector for the attachable/detachable memory; and an interface circuit and input/output terminal 16 thereof.

The above described attachable/detachable memory accommodation room 17 is mounted on the back surface of an end portion of the main board 15 such that a memory insertion opening of the attachable/detachable memory accommodation room 17 comes to a position corresponding to the lid 9 which is provided on the left side surface as shown in FIG. 1. The attachable/detachable memory is constructed as having a flash memory mounted at the interior thereof and its shape can be either a flat, so-called card type or a rod-like, stick type. Further, the attachable/detachable memory accommodation room 17 is directly mounted on the back surface side of the main board 15 so as to make a harness unnecessary, thereby improving an efficiency of the internal layout. The input/output terminal 16 comprises a plurality of terminals such as a signal terminal for performing exchange of image signal with an external equipment, an external power supply terminal for supplying the camera's driving power from an external source, etc. An opening (not shown) for inserting cable is provided correspondingly to the position of the terminals on the right side surface of the external enclosure of the body. Further, since, as described above, the main board 15 is U-shaped and is extended to the right end portion of the camera body 1, the input/output terminal 16 can be mounted directly on the main board 15 to eliminate a harness thereof, thereby improving an efficiency of the layout.

A battery 14, for supplying power of the electronic camera, is disposed within the grip at the left side of the camera body 1, on the front side of the attachable/detachable memory accommodation room 17 such that it is perpendicular to the bottom surface of the camera body 1. A closing/opening lid for replacing of a battery is disposed on the bottom surface (not shown). An image display section 12 is used for reproduction of a recorded image or as an electronic finder at the time of taking a picture. The image display section 12 is constituted by a liquid crystal or plasma display and its display surface is provided on the back surface of the body so that it can be readily used by the photographer. Further, the image display section 12 is provided between the taking lens unit 11 and the rear cover 1b (see FIG. 5) of the camera body 1 and is located at a position where it does not overlap the attachable/detachable memory accommodation room 17 in the direction of thickness of the camera body 1. Here, a protection glass or the like is not provided at an opening of the rear cover 1b and an image display surface of the image display section 12 is directly exposed from the opening provided on the rear cover 1b to achieve a reduced thickness of the camera body 1. A strobe unit 18 includes a xenon tube disposed at the interior of the above described strobe window 6, a control circuit section for controlling emission of the same, a charging capacitor, etc. Here, the strobe unit 18 is disposed in front of the main board 15 between the taking lens unit 11 and the battery 14 in an orientation where its length direction is parallel to the taking lens unit 11.

FIGS. 4 and 5 show a detailed construction of the taking lens unit 11. FIG. 4 is a sectional view of certain portions as seen from the front, and FIG. 5 is a sectional view of certain portions as seen from the right side. A front fixing frame 30 is retaining a first group lens 19, which is closest to the object, and a reflecting mirror 20.

A shielding member 30a is integrally formed on the front fixing frame 30 between the first group lens 19 and the reflecting mirror 20 so as to shut off harmful light, obliquely incident upon and passing through the first group lens 19, from entering the reflecting mirror 20. The shielding member 30a is integrally formed on an extended portion of the part for supporting the first group lens 19 and has the shape of a wedge narrowed toward the reflecting mirror 20. The reflecting mirror 20, acting as a means for altering image pickup optical axis, is in the form of a thin plate having a rectangular shape. The direction of an image pickup optical axis A, after substantially perpendicularly incident upon the front surface of the camera body and passing through the first group lens 19, is bent by 90 degrees as reflected by the reflecting mirror 20 so as to be directed downward in a vertical direction. Further, a flange portion substantially parallel to the bottom surface of the camera body is formed on the front fixing frame 30 on a plane under the reflecting mirror 20. Formed on this flange portion are a fitting portion for fitting onto distal ends of two guide shafts 36 to be described later and a portion for attaching with a rear fixing frame 31 to be also described later.

A second group lens frame 21 is cylindrical at the interior and opened at both ends thereof and has a flange portion on a part of its periphery. Its cylindrical interior contains two pieces of lens and a fixed aperture stop 21a is integrally formed in the vicinity of one opening end of the cylindrical interior. Further, formed on the above described flange portion of the second group lens frame 21 are fitting portion for fitting onto the two guide shafts 36 for supporting the second group lens frame 21 so as to be displaceable only in the direction of the optical axis, and a cam pin (not shown) for positioning in the optical axis direction. A stop/shutter unit 33 is disposed as fixed in the vicinity of the fixed aperture stop 21a of the second group lens frame 21. The stop/shutter unit 33 is a device for mechanically adjusting quantity of light reaching the image pickup device and is provided at the interior of a disk-like body thereof with sectors for stop and sectors for shutter so as to be respectively retractable from the optical path. Driving of the stop sectors and shutter sectors is effected by drive sources 33a located as independent from each other at the outside of the disk-like body.

A third group lens frame 22 is cylindrical at the interior and opened at both ends thereof and has a flange portion on a part of its periphery in a similar manner as the second group lens frame 21. It is provided with two pieces of lens at the cylindrical interior thereof, and the flange portion is formed with fitting portion for fitting onto the two guide shafts 36 for supporting the third group lens frame 22 so as to be displaceable only in the direction of the optical axis and a cam pin 22a for positioning in the direction of the optical axis. A fourth group lens frame 23 has the shape of a hollow disk and retains a piece of lens at the interior thereof, and, similarly to the second group lens frame 21, is formed with fitting portion for fitting onto the two guide shafts 36 for supporting the fourth group lens frame 23 so as to be displaceable only in the direction of the optical axis and an end portion 23a for restricting position in the direction of the optical axis.

A rear fixing frame 31 has a vertically elongated, substantially cylindrical shape and is disposed so that a length direction thereof is perpendicular to the bottom surface. Here, its interior is formed mainly with a section for accommodating lenses at an upper part and a section for accommodating image pickup device, etc., at a lower part and is partially partitioned by a flange portion formed in the course thereof. The above described two guide shafts 36 for supporting each of the group lens frames so as to be displaceable in the direction of the optical axis are implanted in a vertical direction in the bottom surface of the flange portion at the cylindrical interior of the rear fixing frame 31. Through these guide shafts 36, the above described second group lens frame 21, third group lens frame 22 and fourth group lens frame 23 are disposed from top to bottom in that order within the cylinder of the rear fixing frame 31, so as to be displaceable only in the direction of the optical axis. Further, the fourth group lens frame 23 is connected through a spring (not shown) to the rear fixing frame 31 so as to be continuously forced toward the bottom surface of the camera body.

Disposed within the above described section for accommodating image pickup device etc., partitioned by the flange portion of the rear fixing frame 31 are a low-pass filter 24 in the form of a flat plate for preventing moire effect, an IR cut filter 25 also in the form of a flat plate for cutting infrared optical components, an elastic member for example of a rubber material for absorbing displacement, and an image pickup device 27, from top to bottom in that order. The planes of the flat plates of the low-pass filter 24 and IR cut filter 25 are disposed substantially in parallel to the bottom surface of the camera body, and the image pickup surface of the image pickup device 27, too, is disposed substantially in parallel to the bottom surface. Here, a fixing plate 28 is fixed to the rear fixing frame 31 such as by means of screws while pressing the reverse side of a package surface of the image pickup device 27. The low-pass filter 24, IR cut filter 25 and image pickup device 27 are thereby stably retained by means of the elasticity of the elastic member 26 at the interior of the section for accommodating image pickup device, etc.

Further, a flexible cable 29 for electrically connecting the image pickup device 27 to a part of the camera body is mounted on a terminal of the image pickup device 27, and one side surface of the flexible cable 29 is adhered and fixed to the fixing plate 28 such as by means of an adhesive tape having both sides coated. The flexible cable 29 is connected at the other end thereof to a connector which is mounted on the image pickup board 13.

The lens displacing mechanism is constituted by a zoom section and an AF section. A cam cylinder 32, a cylindrical cam for displacing the second group lens frame 21 and third group lens frame 22 of the lens displacing mechanism, is disposed within the cylindrical lens accommodation section of the rear fixing frame 31 and has an external shape so as to slide, while turned, against an internal wall of the lens accommodation section. Integrally formed, respectively, on the circumference of the cam cylinder 32 are cam groove for displacing the second group lens frame 21 and third group lens frame 22 and a driving gear section 32a. Further, the above described cam groove is formed so that a cam pin (not shown) of the second group lens frame 21 and the cam pin 22a of the third group lens frame 22 are fitted therein. The above described cam cylinder 32 is turned by a zoom motor 35. The zoom motor 35 is fixed on the left side portion of the taking lens unit 11 at the outside of the rear fixing frame 31 and includes a reduction gear mechanism for zoom drive. An output gear of the zoom motor 35 is meshed with the above described gear section 32a of the cam cylinder 32.

Further, an AF motor 34 for focusing, which is also one of the driving sources for the lens displacing mechanism, is disposed at the outside of the rear fixing frame 31 on the right side portion of the taking lens unit 11 which is opposite to the side of the zoom motor 35. A lead screw is formed on the output shaft of the AF motor 34, and a displacing plate 34a is threaded on the lead screw shaft and is capable only of linear displacement by a restriction means (not shown). Here, the displacing plate 34a is engaged with the end portion 23a of the fourth group lens frame 23. Since the zoom motor 35 and AF motor 34 are disposed at positions separated to the left and right such that both do not overlap the image display section 12 at the interior of the camera body 1 in the direction of thickness thereof, this is convenient for a reduction in thickness of the camera body. Further, the driving source 33a of the stop/shutter unit 33, AF motor 34, zoom motor 35 and an electrical position detection sensor, etc., for detecting such as an initial position of each lens group are connected to the internally provided main board 15 through flexible cable (not shown).

A brief description will be given below with respect to displacement of each lens group. At the time of zoom, the zoom motor 35 is rotated by zoom operation of an operator so that the cam cylinder 32 is turned through the gear section 32a. Since the second group lens frame 21 and third group lens frame 22 are restricted by the guide shafts 36 so as to be movable only in the direction of the optical axis, the second group lens frame 21 and third group lens frame 22 are displaced, correspondingly to a turned angle of the cam cylinder 32, to a predetermined position in the direction of the optical axis by way of respective cam pins that are fitted in the cam groove formed on the cam cylinder 32. Also, at the time of AF, the AF motor 34 is rotated in association with a zoom movement of the second group lens frame 21 and third group lens frame 22 or by an operation by the photographer, and the displacing plate 34a of which only translation is allowed is displaced in the direction of the optical axis corresponding to the rotation of the lead screw. Here, since the fourth group lens frame 23 is continuously forced toward the image pickup device 27 and is abutted against the displacing plate 34a through the end portion 23a thereof, it is positioned corresponding to the displacing plate 34a.

It should be noted that, while the above embodiment has been described in a construction where adjustment of AF is achieved by displacement of lens, it is naturally also possible to focus by displacing the image pickup device 27 in the direction of the optical axis instead of the fourth group lens frame 23. In such case, the forth group lens frame 23 is positioned and fixed at the interior of the lens accommodation section of the rear fixing frame 31, and the image pickup device 27, which has previously been contained in the section for accommodating image pickup device, etc., of the rear fixing frame 31, is contained in a retaining member which is separate from the rear fixing frame 31. The retaining member, then, is constructed as movable in the direction of the optical axis by a combination of two guide shafts 36 and AF motor 34 having a lead screw thereon in a similar manner as the above described displacement of the fourth lens frame 23. At this time, since it is not necessary to move the low-pass filter 24 and IR cut filter 25, they are retained within an accommodation section of the rear fixing frame 31 by means of the fixing plate 28. AF motor 34 is also fixed on the rear fixing frame 31 in a similar manner. When AF adjustment is effected by thus providing a means for displacing the image pickup device in the direction of the optical axis, the construction of the taking lens system becomes simpler and a unit corresponding to AF and a unit of fixed focus can be suitably used. It is thus easier to give a variation in types of the body.

Further, while one having the fixed aperture stop 21a integrally formed on the second lens frame 21 has been shown in the present embodiment, it is also possible for example to provide a fixed aperture stop on the reflecting mirror 20. In particular, it can be readily achieved by forming a metal film on the reflecting surface by means of printing or coating or by pasting thereto a black thin plate having an opening at the center thereof. Since the reflecting mirror 20 is flat along its surface, it is easier to provide a fixed aperture stop thereon comparing to a lens having a curved surface. Further, it is also possible to use a reflecting mirror having a coating of infrared cutting film. In such case, the IR cut filter 20 naturally becomes unnecessary. It should be noted that, the reflecting mirror 20 can naturally be replaced by a prism.

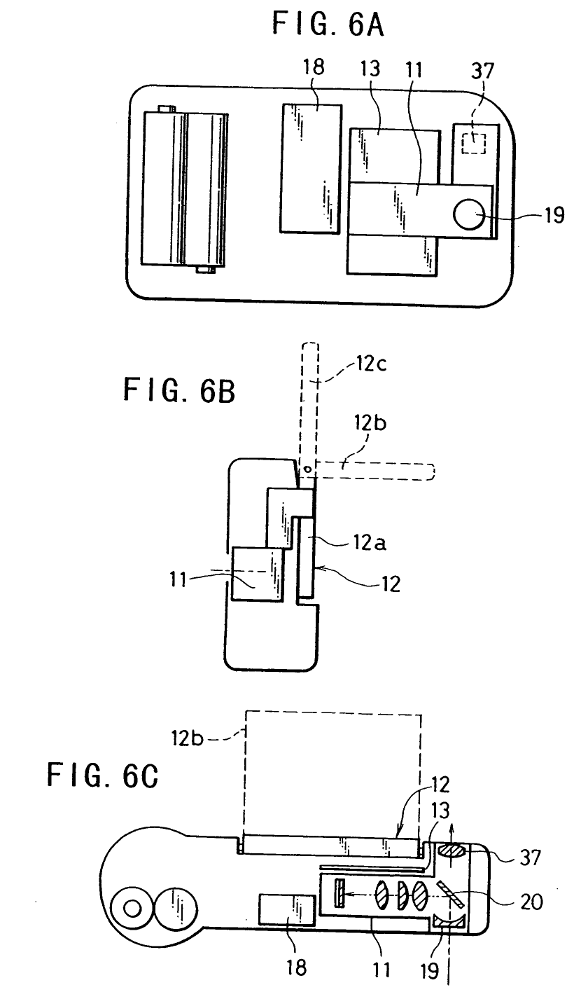

A second embodiment of the present invention will now be described by way of FIGS. 6A to 6C. FIG. 6A shows an layout of taking lens unit 11, image display section 12, etc., as viewed from the front, FIG. 6B from the right side and FIG. 6C from the top. A reflecting mirror 20 is disposed at the interior of the taking lens unit 11 in a similar manner as the first embodiment so that an incident light is bent by 90 degrees. Here, the taking lens unit 11 is disposed at the interior of the camera body such that the bent image pickup optical axis is parallel to both the bottom surface and the back surface of the camera body 1, or in other words is horizontal at the time of a customary picture taking. Further, the taking lens unit 11 is laid out at the interior of the body so that a first group lens 19 is positioned in the vicinity of the right end of the body. The reason for this is that, if the taking lens unit 11 is located at a center portion of the camera body 1, an adequate space cannot be secured and an effective use thereof is difficult though a little space is provided on the right and left sides of the taking lens unit 11. Also, if the first group lens 19 is located at the right end, an optical finder, too, can be positioned in the vicinity of the right end so that the vicinity of the center portion of the body can be effectively used. Since, thereby, the length direction of the taking lens unit 11 is parallel to the bottom surface, it is possible to reduce thickness of the camera body and at the same time to lower its height.

Furthermore, the reflecting mirror 20 is constituted by a half-mirror so that light rays after passing through the first group lens 19 are divided into two components. The reflected light rays reach the image pickup device through the respective taking lenses in a similar manner as the first embodiment. Respective lenses for an optical finder (not shown) are disposed at the back of the reflecting mirror 20 which is a half-mirror, so that the transmitted light rays are used as the light rays for the optical finder. An image of the object passed through the respective lenses is observed from an ocular section 37 provided on rear cover 1b. Since an optical finder of single lens reflex camera type can be constructed by using the reflecting mirror 20 within the taking lens unit 11, a finder image without a parallax can be obtained while maintaining a reduced thickness.

Further, instead of dividing the object light into two components by a half-mirror (beam splitter), it is also possible to alter the direction of the object light by suitably turning the reflecting mirror 20. For example, the reflecting mirror 20 is formed as an ordinary reflection type which is not a half-mirror and it is constructed as turnable by about 45 degrees clockwise, such as by means of a motor, about the right end of the reflecting mirror 20 as shown in FIG. 6C. Here, in its ordinary state, the reflecting mirror 20 is at the 45-degree turned position so as to be withdrawn from the rays of an object light, thereby the object light entering only into the optical finder system so that the photographer is to decide composition, etc., while observing the object through the ocular section 37. Next, when the release switch 7 is pressed, the reflecting mirror 20 is automatically turned counterclockwise by 45 degrees to guide the object light toward the image pickup device so that a picture is taken and recorded after operation of AF/AE, etc. By thus employing a construction where an object light is guided to the image pickup device only during a very short time of taking a picture by switching an angle of the reflecting mirror 20 without splitting the object light into two components, a finder image without a parallax can be obtained and at the same time there is no reduction in quantity of light reaching the image pickup device. Correspondingly, a photographed image having a high image quality can be obtained.

An image pickup plate 13 mainly mounting an image pickup circuit for performing drive control of the image pickup device, processing of electrical signal photoelectrically converted by the image pickup device, etc., is disposed in parallel to the back surface of the camera body between the taking lens unit 11 and an image display section 12. Further, the image display section 12, which has been fixed at the interior of the body in the first embodiment, is constructed as turnable. In particular, the image display section 12 is disposed at the outside of the tear cover 1b so as to be turnable around pivots provided on the right and left. The image display section 12 turns through about 180 degrees among a normal position 12a where it is in close proximity to the rear cover 1b, a horizontal position 12b where its image displaying surface is parallel to the bottom surface of the body and an inverted position 12c where its image displaying surface faces the object.

Here, in the case where the image display section is used as an electronic finder by the photographer at the time of taking a picture, there is a problem that, at the normal position 12a, it, unlike an optical finder, cannot be viewed very well unless the eye is at a certain distance or more from the body. Since, thereby, underarm part of the hand grasping the camera is opened to make less steadfast the holding of the camera, this becomes a cause of a camera shake at the time of telephotography or low shutter speed. Accordingly, by taking a picture while keeping the image displaying surface in the horizontal position 12b at the level of the waist in telephotography or at the time of low shutter speed, a camera shake is not likely to occur, since the underarm part is kept tight even in the state where the eye is distant from the camera body.

Further, this horizontal position 12b is naturally effective when taking a picture of an object located at a position close to the ground. Furthermore, at the inverted position 12c, by using a construction where an image on the image displaying surface is automatically displayed upside down upon detection of a turning angle of image display section, a picture can be taken easily while viewing the image displaying surface for example when the photographer takes a picture of one's own face with directing the camera toward oneself.

While the above embodiments have been described as applying the present invention to an electronic camera which is a type of electronic image pickup apparatus, the present invention is not limited to an electronic camera and can naturally be applied to a video camera, etc., provided that an image pickup device is used therein.

What is claimed is:

1: An electronic image pickup apparatus having an image pickup device for effecting photoelectric conversion of object light, said electronic image pickup apparatus comprising:
an image display section disposed on a back side of the apparatus for displaying images;
a turning mechanism for turning said image display section from a position where it is in close proximity to the back side of the apparatus to a position where it is separated by a certain angle from the back side of the apparatus; and
a taking lens unit having a plurality of lenses, and a mirror section for altering the direction of image taking optical axis so that object light entered from a front side of the apparatus is caused to advance in parallel to the back side and a bottom side of the apparatus to form an image on the image pickup device.

2: The electronic image pickup apparatus according to claim 1 further comprising a single lens reflex camera type optical finder for viewing an object image with using light rays incident on said taking lens unit.
